(19) United States
(12) Patent Application Publication
(10) Pub. No.: US 2025/0016664 A1
(43) Pub. Date: Jan. 9, 2025

(54) CLUSTERING OF ACCESS POINTS IN A WIRELESS TELECOMMUNICATIONS NETWORK AND CONFIGURATION OF AN ACCESS POINT IN A CLUSTER

(71) Applicant: BRITISH TELECOMMUNICATIONS PUBLIC LIMITED COMPANY, LONDON (GB)

(72) Inventors: Timothy SANMOOGAN, London (GB); Arjun PAREKH, London (GB); Rebecca REID, London (GB)

(21) Appl. No.: 18/711,714

(22) PCT Filed: Oct. 6, 2022
(86) PCT No.: PCT/EP2022/077779

§ 371 Date: May 20, 2024

(30) Foreign Application Priority Data
Nov. 26, 2021 (GB) 2117099. 8

(51) Int. Cl. H04W 48/16; H04W 16/32; H04W 24/02; H04W 24/08

(52) U.S. Cl. CPC H04W 48/16; H04W 16/32; H04W 24/02; H04W 24/08

(57) ABSTRACT

This disclosure provides a method of configuring a first access point in a wireless telecommunications network, the first access point being one of a first plurality of access points, the method including obtaining time-series performance data for each access point of the first plurality of access points; determining a similarity value between the time-series performance data of each access point of the first plurality of access points and the time-series performance data of each other access point of the first plurality of access points using a dynamic time warping technique; based on the similarity values, identifying a first plurality of clusters of the first plurality of access points, the first access point being a member of a first cluster of the first plurality of clusters; identifying a configuration for the first access point based on its association with the first cluster; and causing the identified configuration of the first access point.

### PRIORITY CLAIM

The present application is a National Phase entry of PCT Application No. PCT/EP2022/077779, filed Oct. 6, 2022, which claims priority from GB Application No. 2117099.8, filed Nov. 26, 2021, each of which hereby fully incorporated herein by reference.

### TECHNICAL FIELD

The present disclosure relates to a method of reconfiguring a wireless telecommunications network.

### BACKGROUND

A wireless telecommunications network may experience a growth in traffic due to an increase in users and/or an increase in the amount of data consumed by one or more users. To forestall any issues that would otherwise occur if this traffic exceeds the capacity of the network, the network operator may upgrade the network. An upgrade to the network may be to add new transceivers, use new radio resources, use new backhaul resources, use new technologies, use new protocols, and/or add additional processing capacity. The network operator may forecast usage growth in the network and upgrade the network to handle the forecasted usage growth. Growth may be forecast at an access point level such that each access point may be upgraded independently of other access points in the network. If the usage growth of an access point is underestimated, then users of the upgraded access point may experience poor service as the traffic demand exceeds capacity in the upgraded access point. If the usage growth is overestimated, then the network operator has wasted resources on the upgrade that could have otherwise been used to upgrade other access points in the network.

The network operator may determine a growth rate for each access point by reviewing its historical performance data and determining its growth rate. However, this requires significant storage and processing resources when there are many access points in the network. A simplified method of forecasting growth of an access point in the network is to estimate a universal growth rate (e.g. 10%) and apply the universal growth rate to each access point in the network. This universal approach reduces the resources required to determine a growth rate for each access point, but is more likely to underestimate or overestimate the growth rate.

Other network configurations also suffer from the same issue that the network operator must either use significant resources to identify a configuration for each access point based on data for each access point, or apply a universal configuration across a plurality of access points that risks being inappropriate for one of more of those access points. This may apply to, for example, the network operator determining a time for switching access points to an energy saving mode.

### SUMMARY

According to a first aspect of the disclosure, there is provided a computer-implemented method of computer-implemented method of configuring a first access point in a wireless telecommunications network, the first access point being one of a first plurality of access points, the method comprising: obtaining time-series performance data for each access point of the first plurality of access points; determining a similarity value between the time-series performance data of each access point of the first plurality of access points and the time-series performance data of each other access point of the first plurality of access points using a dynamic time warping technique; based on the similarity values, identifying a first plurality of clusters of the first plurality of access points; identifying a configuration for the first access point based on an association with a first cluster of the plurality of clusters; and causing the first access point to implement the identified configuration.

The method may be defined as a method of configuring a first access point in a wireless telecommunications network, the first access point being one of a first plurality of access points, the method comprising: obtaining time-series performance data for each access point of the first plurality of access points; determining a similarity value between the time-series performance data of each access point of the first plurality of access points and the time-series performance data of each other access point of the first plurality of access points using a dynamic time warping technique; based on the similarity values, identifying a first plurality of clusters of the first plurality of access points, the first access point being a member of a first cluster of the first plurality of clusters; identifying a configuration for the first access point based on its association with the first cluster; and causing the identified configuration of the first access point.

The first wireless telecommunications network may include a second plurality of access points, determining the similarity value is between each access point of the second plurality of access points and each other access point of the second plurality of access points and identifying the first plurality of clusters may be performed for the second plurality of access points, the method may further comprise: generating time-series performance data for each cluster of the first plurality of clusters; determining a similarity value between the time-series performance data for each access point of the first plurality of access points and the generated time-series performance data for each cluster of the first plurality of clusters; and associating each access point of the first plurality of access points with a cluster of the first plurality of clusters based on the determined similarity value. In other words, the first plurality of access points may include a first subset of access points, and determining the similarity value may be between each access point of the first subset of access points and each other access point of the first subset of access points and identifying the first plurality of clusters may be performed for the first subset of access points, the method may further comprise: generating time-series performance data for each cluster of the first plurality of clusters; determining a similarity value between the time-series performance data for each access point of the first plurality of access points and the generated time-series performance data for each cluster of the first plurality of clusters; and associating each access point of the first plurality of access points with a cluster of the first plurality of clusters based on the determined similarity value.

Generating time-series performance data for each cluster of the first plurality of clusters may be based on an average of the time-series performance data for each access point in the cluster.

The configuration may be determined using a machine learning method using the first access point's association with the first cluster of the first plurality of clusters as an input, wherein the machine learning method may be trained on a dataset identifying historical performance data for each cluster of the first plurality of clusters.

The machine learning method may also use one or more of the following as an input: a density of a site associated with the first access point, an average of the performance data in a particular time period, a height of an antenna of the first access point, a set of carriers used by the first access point, and a vendor of the antenna of the first access point, wherein the dataset for training the machine learning method further identifies corresponding historical metrics for each cluster of the first plurality of clusters.

The time-series performance data may include one or more of a measure of connected users and a measure of resource usage.

The time-series performance data may include a plurality of performance metrics, and the dynamic time warping technique may be a multivariate dynamic time warping technique.

The identified configuration may be one or more of: a capacity of the first access point, a handover parameter of the first access point, and an energy saving mode of the first access point.

The wireless telecommunications network may be a cellular telecommunications network, and the first access point may be a first sector of a first base station.

According to a second aspect of the disclosure, there is provided a computer program comprising instructions which, when the program is executed by a computer, cause the computer to carry out the first aspect of the disclosure. The computer program may be stored on a computer readable carrier medium.

According to a third aspect of the disclosure, there is provided a data processing apparatus comprising a processor adapted to perform the first aspect of the disclosure.

### BRIEF DESCRIPTION OF THE FIGURES

In order that the present disclosure may be better understood, embodiments thereof will now be described, by way of example only, with reference to the accompanying drawings in which:

FIG. 1 is a schematic diagram of a wireless telecommunications network of a first embodiment of the present disclosure.

FIG. 2 is a flow diagram of a first embodiment of a method of the present disclosure.

FIG. 3 is a flow diagram of a second embodiment of a method of the present disclosure.

FIG. 4 is a flow diagram representing both the first and second embodiments of the present disclosure.

### DETAILED DESCRIPTION OF EMBODIMENTS

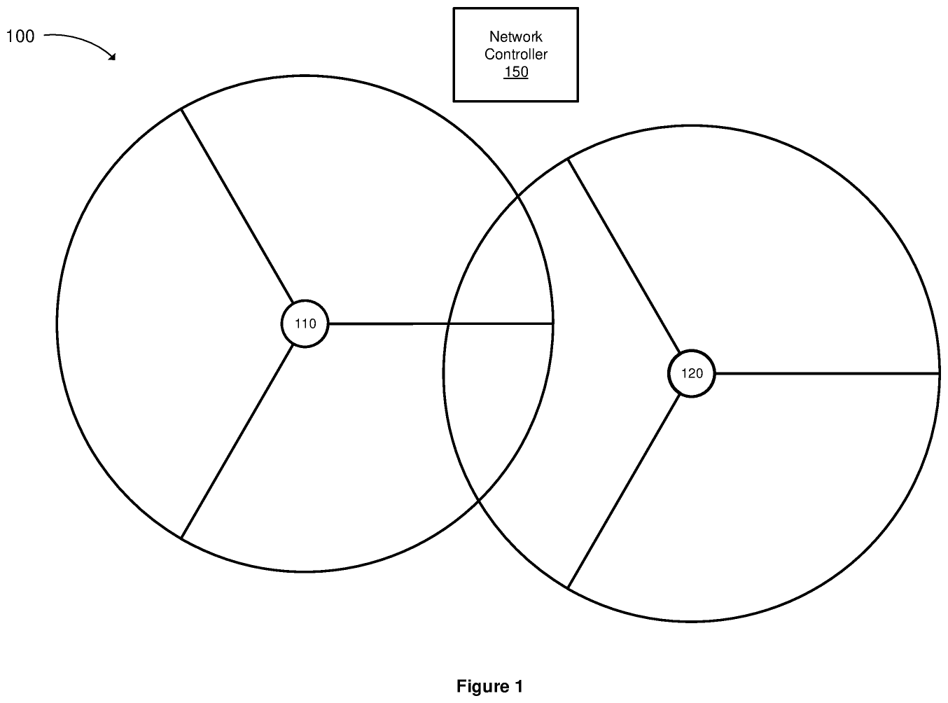

A first embodiment of a wireless telecommunications network 100 will now be described with reference to FIG. 1. In this first embodiment, the wireless telecommunications network 100 is a cellular telecommunications network having a first base station 110 located at a first cell site and a second base station 120 located at a second cell site. The first base station 110 and second base station 120 are both tri-sector base stations (i.e. they each have a first sector, second sector and third sector). Each sector of each base station has a distinct coverage area. Furthermore, each sector of each base station may communicate using a single carrier or a plurality of carriers.

FIG. 1 also illustrates a controller 150. The controller 150 is configured to receive data from each base station, which in this embodiment includes:
an average number of users connected to each carrier of each sector of the base station. Each value for the average number of users is associated with a particular point in time (that is, it is timestamped) to indicate the average number of users connected to a particular carrier of a particular sector of a particular base station at that point in time. In this embodiment, each data point is recorded and timestamped at hourly intervals so as to represent the average number of users connected to each carrier of each sector of the base station in that hour. A data set of such values may cover a particular time period, e.g. a particular week, such that each value for the average number of users is for a particular point of time within that time period;
a density of the cell site where the base station is located (e.g. ‘Dense Urban’, ‘Urban’, ‘Suburban’ and ‘Rural”) based on proximity of the cell site to its four nearest neighbors;
Physical Resource Block (PRB) usage data, including a count of PRBs used by each carrier of each sector of the base station in a time period. In this embodiment, the PRB usage data is also recorded and timestamped at hourly intervals so as to represent the count of PRBs used by each carrier of each sector of the base station in that hour. The data set of such values may cover a particular time period (e.g. a year), which may be different from the time period covered by the data set of the average number of users;
The height of each antenna in each sector of the base station;
The set of carriers communicated in each sector of the base station; and
The manufacturer of each antenna of each sector of the base station.

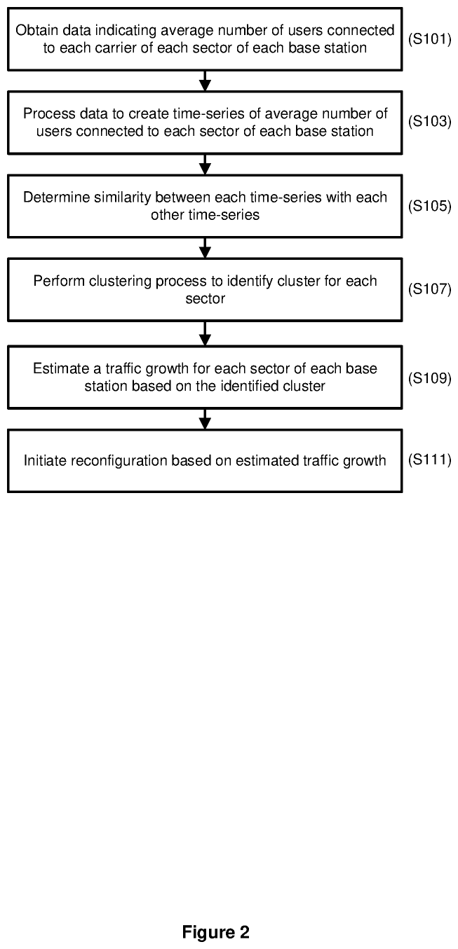

The controller 150 includes a communications interface for receiving this data, memory for storing this data, and a processor for implementing an embodiment of a method of present disclosure to determine a configuration of each sector of each base station in the network 100 based on the data. The data may be stored in memory with a timestamp indicating the time the data was recorded by the base station. The data may also be processed, by the processor, to determine new metrics. A first embodiment of the method will now be described with reference to FIG. 2.

In S101 of this first embodiment, the controller 150 obtains data indicating the average number of users connected to each carrier of each sector of each base station for a plurality of points in time (e.g. each hour) for a particular time period (e.g. a day).

In S103, the controller 150 processes the data to determine the average number of users connected to each sector of each base station at each point in time in the time period. This is achieved by retrieving a value for the average number of connected users of each carrier of a particular sector at a particular point in time (e.g. the values for the average number of users connected to each carrier of a particular sector of a particular base station for 0100 on the first day of the week) and summing those values to determine the average number of users connected to that sector of that base station at that point in time. This is repeated at each point in time for which there are values of the average number of users connected to that sector of that base station. This processed data may then be represented as a vector, v, for a particular sector in which each element of the vector is the average number of users connected to that sector at a particular point in time, and the vector covers each point in time between the start of the time period to the end of the time period. This vector may be described as a time-series of the average number of users for a particular sector for a particular base station over a particular time period. This process is repeated for all sectors of all base stations. Accordingly, following S103, the controller 150 obtains a time-series of the average number of users for each sector of each base station over the time period.

In S105, the controller 150 processes each time-series vector to determine a similarity value with each other time-series vector. This is achieved using a dynamic time-warping technique so as to identify similar time-series pairs that either occur at the same time or are offset in time (in other words, any similar patterns in the two time-series do not necessary have to occur at the same time in order for the two time-series to be identified as similar). In more detail, a first time-series vector, v₁, having n time points and a second time-series vector, v₂, having m time points are processed to calculate a similarity matrix, S. The similarity matrix is a two-dimensional matrix of size n×m. Each entry of the similarly matrix, S[i,j], is calculated by measuring the distance between an i-th point in the first time series, v₁ (in which i is a set of 1 to n), and a j-th point in the second time series, v₂ (in which j is a set of 1 to m), and determining the value of S[i,j] as the sum of this distance and the minimum of S[i−1,j], S[i−1] and S[i−1, j−1], such that each entry is monotonically increasing from previous entry of the similarity matrix. A value of similarity between the two vectors is determined as the value of S[n,m]. The following pseudocode includes more detail on the dynamic time-warping method used in this first embodiment:

```
DTW(v₁, v₂) {
//where the vectors v₁=(a₁,...,aₙ), v₂=(b₁,...,bₘ) are the time series with n and m time
points respectively
  Let a two dimensional data matrix S be the store of similarity measures such
that S[0,...,n, 0,...,m], and i, j, are loop index, cost is an integer.
  // initialize the data matrix
  S[0, 0] := 0
  FOR j := 1 to m DO LOOP
    S[0, j] := ∞
  END
  FOR i := 1 to n DO LOOP
      S[i, 0] := ∞
  END
  // Using pairwise method, incrementally fill in the similarity matrix with the
differences of the two time series
  FOR i := 1 to n DO LOOP
    FOR j := 1 to m DO LOOP
    // function to measure the distance between the two points
      cost := d(v_{1[}[i], v₂[j])
```

| | |
|---|---|
| S[i,j] := cost + MIN(S[i−1, j], | // increment |
| | S[i, j−1], // decrement |
| | S[i−1, j−1]) // match |

```
    END
  END
  Return S[n,m]
```

It is noted that this particular time-warping method requires the two time series to both have the same initial time point (that is, a₁ and b₁ occur at the same time) and the same final time point (that is, aₙ and bₘ occur at the same time).

Following S105, the controller 150 has computed a similarity value between each time-series vector and each other time-series vector. In S107, the controller 150 performs a clustering process to identify a plurality of time-series clusters, wherein each time-series vector cluster includes one or more time-series vectors. In this embodiment, the clustering process is based on Ward's method, such that a time series vector is clustered with one or more other time-series vectors if their similarity values are sufficiently close (i.e. relative to a threshold). This threshold may be varied to change the number of clusters resulting from the clustering process. In one implementation, an operator may supervise the clustering process and set the threshold such that the resulting clusters are representative of particular use cases. In another implementation, the threshold may be calculated so as to identify a specific number of clusters.

In this embodiment, the clustering process is implemented using the scipy.cluster.hierarchy.ward function of the Python programming language, as detailed in https://docs.scipy.org/doc/scipy/reference/generated/scipy.cluster.hierarchy.ward.html. Each cluster is identified by a cluster identifier.

Following S107, the controller 150 has identified a cluster for each time-series vector (relating to a particular sector of a base station). In S109, the controller 150 estimates a traffic growth rate for each sector of each base station in the network based on the identified cluster. In this embodiment, the growth rate for a sector is based on a function that uses the following inputs (collected in S101):
The cluster identifier for the sector;
The maximum PRB usage for the previous calendar year for the sector (being a maximum of the sum of PRB usage for each carrier of that sector);
The mean PRB usage in the January of the current calendar year for the sector (being a mean of the sum of the PRB usage in January for each carrier of that sector);
a density of the cell site where the base station of that sector is located (e.g. ‘Dense Urban’, ‘Urban’, ‘Suburban’ and ‘Rural”);
The height of the sector's antenna;
The set of carriers communicated by that sector; and
The manufacturer of the sector's antenna.

This function is developed using a supervised machine learning model, such as a decision tree, based on a labelled training dataset (mapping between these inputs for a particular sector and the known growth rate for that sector). The trained decision tree may also be applied to a further testing dataset and reviewed to determine whether the function is outputting accurate growth rates for each sector in the testing dataset. The decision tree may be retrained one or more times following review of the output growth rates when applied to the testing dataset. The trained and tested function may also be applied to a validation dataset as a final test to ensure the function is performing as intended. The function may then be used in S109 to estimate a traffic growth rate for each sector of each base station in the network based on the identified cluster.

In S111, the controller 150 causes a reconfiguration of the network based on the estimated traffic growth rate for each sector of each base station in the network. This reconfiguration may be to upgrade the capacity of each sector such that each sector can handle the amount of additional traffic expected before the next upgrade (the additional traffic being the growth rate multiplied by the time until the next upgrade). The reconfiguration may also be timed such that the upgrade is performed before the traffic increases above the sector's current capacity.

The above embodiment provides the benefit of calculating a growth forecast that is based on behavioral trends. That is, by identifying that a particular sector of a base station is a member of a particular cluster, then the growth forecast may be based on a traffic growth trend for that cluster. For example, if the sector of a base station is clustered with other sectors that primarily serve office worker customers, then the growth forecast may be based on the expected growth in traffic for such customers. Accordingly, changes in behavior experienced by some sectors in a cluster may alter the growth rate predictions of other sectors in the cluster, even if those other sectors have not yet experienced those behavioral trends. These predictions based on the cluster identifier are therefore more accurate and responsive than existing methods that apply a universal growth rate to each sector.

Another benefit of upgrading a sector based on its cluster identifier is that the upgrade may be suitable for customers associated with that cluster. For example, if a sector is clustered with other sectors that primarily serve commuters, then the sector may be upgraded to increase its range by using a lower frequency transceiver (reducing the likelihood of users served by that sector being handed over). Conversely, if a sector is clustered with other sectors that primarily serve stationary customers (e.g. suburban or business park customers), then the sector may be upgraded to increase its throughput by using a higher frequency transceiver.

Furthermore, this clustering is performed based on similarities between time-series vectors that do not necessary have to occur at the same time in order for the two time-series to be identified as similar. This allows for time-series that have similar trends that are offset in time to be determined as similar, increasing the likelihood that those time-series vectors are associated with an appropriate cluster.

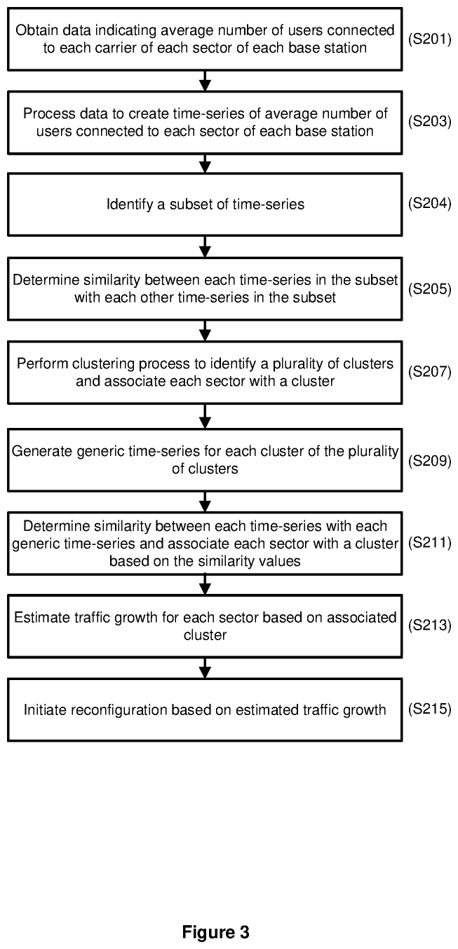

In the above embodiment, a similarity value is calculated between each time-series vector and each other time-series vector. However, as the number of time-series vectors increases, the computational resources requirement may exceed the computational resources of the controller 150. This is addressed in the following second embodiment (illustrated in FIG. 3).

In S201 of this second embodiment, the controller 150 obtains data indicating the average number of users connected to each carrier of each sector of each base station for a plurality of points in time (e.g. each hour) for a particular time period (e.g. a day). In S203, the controller 150 processes the data to obtain a set of time-series vectors, each representing the average number of users for a particular sector of a particular base station over the time period.

In S204, the controller 150 identifies a subset of time-series vectors from the set of time-series vectors. The subset of time-series vectors is selected such that a count of time-series vectors in the subset can be processed in S205 in less than a threshold time (set by the operator based on their computational resources). In S205, the controller 150 processes each time-series vector in the subset of time-series vectors to determine a similarity value with each other time-series vector in the subset of time-series vectors. S205 of this second embodiment uses the same dynamic time-warping technique as detailed in S105 of the above first embodiment. Once these similarity values have been calculated, the controller 150 performs (in S207) a clustering process to identify a plurality of time-series clusters, wherein each time-series vector cluster includes one or more time-series vectors of the subset of time-series vectors. S207 of this second embodiment also uses Ward's method to perform this clustering, as discussed in S107 of the above first embodiment. Following S207, the controller 150 has identified a cluster for each time-series vector in the subset of time-series vectors (relating to a particular sector of a base station). Each cluster is associated with a cluster identifier.

In S209, the controller 150 creates a generic time-series vector for each cluster of the plurality of time-series clusters. A generic time-series vector for a time-series cluster is based on all time-series vector members of that time-series cluster. Each element of the generic time-series vector is an average of the corresponding element of each time-series vector, in which each element of the generic time-series vector and the corresponding element of each time-series vector in the time-series cluster relate to the same point in time. The generic time-series vector of a time-series cluster is therefore an average of the time-series vectors in that time-series cluster.

In S211, the controller 150 processes each time-series vector in the set of time-series vectors (that is, all time-series vectors computed in S203) to determine a similarity value with the generic time-series vectors of each time-series cluster. This is also performed using the same dynamic time-warping technique as detailed in S105 in the above first embodiment. The controller 150 associates each time-series vector in the set of time-series vectors with a cluster identifier based on these similarity values. In this embodiment, this association is such that each time-series vector in the set of time-series vectors is associated with the cluster identifier of the time-series cluster with which it has the greatest similarity value.

In S213, the controller 150 estimates a traffic growth for each sector of each base station in the network based on the identified cluster. This is carried out using the same technique detailed in S109 above. In S215, the controller 150 initiates a reconfiguration in the network based on the estimated traffic growth.

In the above embodiments, the cluster identifier for a sector is used alongside PRB usage data to determine a suitable upgrade for that sector (based on its estimated growth) and when that upgrade should be carried out. It is non-essential that a performance metric is used alongside the cluster identifier in the machine learning algorithm to determine the suitable network reconfiguration. If a performance metric is used, then it is also non-essential that it represents PRB usage (and alternatively or additionally may represent data throughput or count of connected users). Furthermore, the cluster identifier may be used for other network configurations. For example, if the sector is a member of cluster which is characterized by very low utilization during a particular time period, then the network operator may apply a reconfiguration of that sector at that time period (such as a switch to an energy saving mode) or apply a physical operation during that time period (such as to upgrade the sector). In another example, if the sector is a member of a cluster which is characterized by commuter traffic, then the network operator may apply a reconfiguration to alter handover parameters so that users are handed over less frequently.

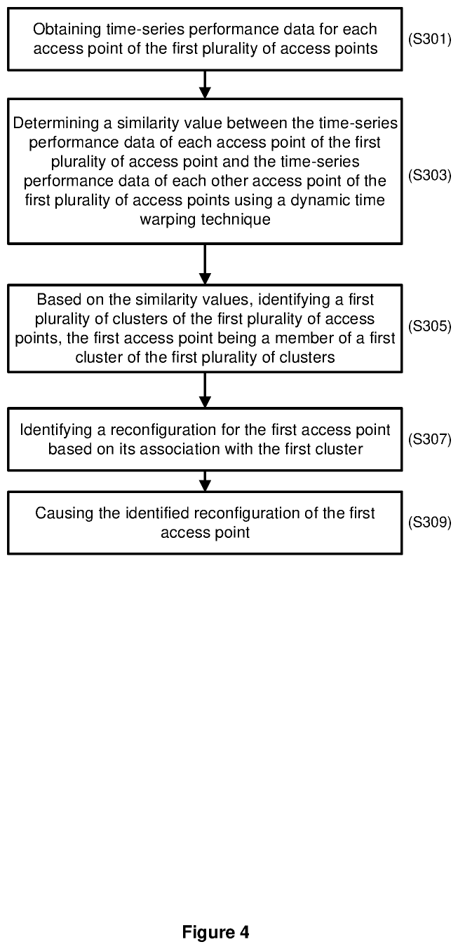

Furthermore, in the above embodiments, the similarity calculation is performed on time-series vectors for the average number of connected users. The skilled person will understand that the average number of connected users is just one example metric and other metrics may be used (so long as they are associated with a point in time such that a time-series of the metric can be created), such as data throughput or physical resource block usage. Accordingly, embodiments of the present disclosure may be represented by the flow diagram of FIG. 4, which includes: obtaining time-series performance data for each access point of the first plurality of access points (S301); determining a similarity value between the time-series performance data of each access point of the first plurality of access point and the time-series performance data of each other access point of the first plurality of access points using a dynamic time warping technique (S303); based on the similarity values, identifying a first plurality of clusters of the first plurality of access points, the first access point being a member of a first cluster of the first plurality of clusters (S305); identifying a reconfiguration for the first access point based on its association with the first cluster (S307); and causing the identified reconfiguration of the first access point (S309).

In a further enhancement to the above first and second embodiments, a plurality of metrics may be used in the similarity calculation using a multivariate dynamic time warping technique. This may be achieved by either 1) obtaining a time-series for each metric and performing dynamic time warping between each pair of time-series for each metric (i.e. independent multivariate dynamic time warping), and summing the similarity values, or 2) obtaining a time-series representing a plurality of metrics and performing dynamic time warping between each pair of multivariate time-series (in which points are aligned in a multi-dimensional matrix). Once a similarity value has been computed between each pair of sectors having multivariate time-series, the process may then continue to cluster the sectors, and determine a network configuration for a sector based on its cluster, as described above in the first and second embodiments. Principal Component Analysis (PCA) may be applied to the multivariate time-series to reduce the number of input variables whilst retaining a significant amount of the information. The output of the PCA may be used as input in the dynamic time warping technique.

In the above embodiments, each sector of a base station is considered as an individual access point and a growth forecast is predicted for that access point. However, the skilled person will realize that the growth forecast may be considered for a single base station. Furthermore, the skilled person will understand that the present disclosure is not limited to cellular telecommunications networks. That is, it may be applied to any wireless telecommunications network having a plurality of access points.

The skilled person will understand that any combination of features is possible within the scope of the disclosure as claimed.

1. A computer-implemented method of configuring a first access point in a wireless telecommunications network, the first access point being one of a first plurality of access points in the wireless telecommunications network, the method comprising:
obtaining time-series performance data for each access point of the first plurality of access points;
determining a similarity value between the time-series performance data of each access point of the first plurality of access points and the time-series performance data of each other access point of the first plurality of access points using a dynamic time warping technique;
based on the determined similarity values, identifying a first plurality of clusters of the first plurality of access points;
identifying a configuration for the first access point based on an association of the first access point with a first cluster of the first plurality of clusters; and
causing the first access point to implement the identified configuration.

2. A computer-implemented method of configuring a first access point in a wireless telecommunications network, the wireless telecommunications network comprising a first plurality of access points and a second plurality of access points, the first access point being one of the first plurality of access points in the wireless telecommunications network, the method comprising:
obtaining time-series performance data for each access point of the second plurality of access points;
determining a similarity value between the time-series performance data of each access point of the second plurality of access points and the time-series performance data of each other access point of the second plurality of access points using a dynamic time warping technique;
based on the determined similarity values, identifying a first plurality of clusters of the second plurality of access points:
generating time-series performance data for each cluster of the first plurality of clusters;
determining a first similarity value between the time-series performance data for each access point of the first plurality of access points and the generated time-series performance data for each cluster of the first plurality of clusters;
associating each access point of the first plurality of access points with a first cluster of the first plurality of clusters based on the determined first similarity value;
identifying a configuration for the first access point based on an association of the first access point with the first cluster of the plurality of clusters; and
causing the first access point to implement the identified configuration.

3. The computer-implemented method as claimed in claim 2, wherein generating time-series performance data for each cluster of the first plurality of clusters is based on an average of the time-series performance data for each access point in the cluster.

4. The computer-implemented method as claimed in claim 1, wherein the configuration is determined using a machine learning method using the association of the first access point with the first cluster of the first plurality of clusters as an input, wherein the machine learning method is trained on a dataset identifying historical performance data for each cluster of the first plurality of clusters.

5. The computer-implemented method as claimed in claim 4, wherein the machine learning method uses one or more of the following as an input: a density of a site associated with the first access point, an average of the performance data in a particular time period, a height of an antenna of the first access point, a set of carriers used by the first access point, or a vendor of the antenna of the first access point,
wherein the dataset for training the machine learning method further identifies corresponding historical metrics for each cluster of the first plurality of clusters.

6. The computer-implemented method as claimed in claim 1, wherein the time-series performance data includes one or more of a measure of connected users or a measure of resource usage.

7. The computer-implemented method as claimed in claim 1, wherein the time-series performance data includes a plurality of performance metrics, and the dynamic time warping technique is a multivariate dynamic time warping technique.

8. The computer-implemented method as claimed in claim 1, wherein the identified configuration is one or more of: a capacity of the first access point, a handover parameter of the first access point, or an energy saving mode of the first access point

9. The computer-implemented method as claimed in claim 1, wherein the wireless telecommunications network is a cellular telecommunications network.

10. The computer-implemented method as claimed in claim 9, wherein the first access point is a first sector of a base station.

11. A computer program comprising instructions which, when the program is executed by a computer, cause the computer to carry out the method of claim 1.

12. A computer readable carrier medium comprising the computer program of claim 11.

13. A data processing apparatus comprising a processor adapted to perform the method of claim 1.
